(19) United States
(12) Patent Application Publication
(10) Pub. No.: US 2025/0149672 A1
(43) Pub. Date: May 8, 2025

(54) Battery Modules Having Formed-In-Place Thermal-Management Components, and Methods of Making Such Battery Modules

(71) Applicant: SES (Shanghai) Co., Ltd., Shanghai (CN)

(72) Inventors: Xianjie Wang, Shanghai (CN); Jiwei Liang, Shanghai (CN); Chengcheng Zheng, Shanghai (CN)

(21) Appl. No.: 18/528,143

(22) Filed: Dec. 4, 2023

(30) Foreign Application Priority Data
Nov. 7, 2023 (CN) 202311476810X

(51) Int. Cl. H01M 10/653; H01M 10/647; H01M 10/651; H01M 10/655

(52) U.S. Cl. CPC H01M 10/653; H01M 10/647; H01M 10/651; H01M 10/655

(57) ABSTRACT

The present application relates to battery modules and methods of making battery modules. Battery modules having formed-in-place thermal-management components, made from flowable material, that during use of the battery modules functions to conduct heat from battery cores inside the battery modules to heat sinks located outside the battery modules. In some embodiments, the battery module has a housing made of a relatively lightweight material that has a relatively low thermal conductivity, and the formed-in-place thermal-management component is made of a material that has a thermal conductivity higher than the thermal conductivity of the housing material. Methods of making such formed-in-place thermal-management component are also disclosed.

### FIELD OF THE DISCLOSURE

The present disclosure generally relates to the field of electrochemical batteries. In particular, the present disclosure is directed to battery modules having formed-in-place thermal-management components, and methods of making such battery modules.

### BACKGROUND

In some conventional designs, a battery module is composed of a battery core, such as, for example, a stack of pouch-type electrochemical cells, housed in a rigid housing made of a resin-based material, such as a resin-impregnated carbon-fiber cloth. The housing in such a module has a relatively low thermal conductivity that is typically on the order of 0.2 W/mK to 0.3 W/mK. When the module does not include any thermal management component, such as a heat sink, thermal excursions can cause the battery management system to shut down charging or discharging, depending on the mode of operation during the thermal excursion. Of course, both shutting down charging and shutting down discharging can seriously impact the operation of the electrical device/equipment that the battery module has been provided to power.

In other conventional designs, a battery module having a composite housing includes a thermal management component, such as an aluminum plate that is integrated into the bottom wall of the housing so as to act as a heat sink for the battery core. The aluminum plate is located in an opening in the bottom wall and extends from the exterior of the housing to the interior of the housing, and is placed into thermal communication with the battery core, typically with electrical insulation placed between the battery core and the aluminum plate to keep the battery core electrically isolated within the housing. While the aluminum plate allows for thermally managing the battery core, it can nearly double the weight of the housing, negatively impacting the gravimetric energy density of the battery module.

### SUMMARY OF THE DISCLOSURE

In one implementation, the present disclosure is directed to a battery module, which includes a housing that encloses a first interior space, the housing having a wall composed of a first dielectric material and having an exterior side; a battery core comprising one or more electrochemical cells; and a formed-in-place thermal-management component extending through the wall of the housing so that, during use of the battery module, the formed-in-place thermal management component can conduct heat from the battery core to the exterior side of the wall when the battery core generates the heat.

In another implementation, the present disclosure is directed to a method of making a battery module. The method includes providing the battery module, wherein the battery module comprises a housing that encloses an interior space and has a wall composed of a first dielectric material and having an exterior side, the wall having a plurality of apertures, the interior space containing a battery core; applying a flowable material to the wall so as to flow through the plurality of apertures and into the interior space and contact the battery core and fill the plurality of apertures; and causing the flowable material to solidify so as to create a formed-in-place thermal-management component that will conduct heat, generated by the battery core during use, through the wall of the housing.

In some embodiments, the interior space contains a battery core, and the applying a flowable material to the wall includes applying a flowable thermally conductive material so that the flowable thermally conductive material contacts the battery core.

In some embodiments, the flowable material comprises a thermally conductive adhesive.

In some embodiments, the method further comprises, prior to applying the flowable material, engaging a thermal-management-component forming tool with the housing.

In some embodiments, the plurality of apertures are distributed over an apertured region of the wall having a first area; the thermal-management-component forming tool includes an opening having a second area equal to or greater than the first area; and engaging the thermal-management-component forming tool with the housing includes engaging the thermal-management-component forming tool with the housing so that the opening is in registration with the apertured region of the wall.

In some embodiments, the thermal-management-component forming tool has a frame defining the opening and configured to engage the wall outside the apertured region, the frame having a first thickness for defining edges of an external portion of the formed-in-place thermal-management component.

In some embodiments, the wall is made of a first dielectric material.

In some embodiments, the formed-in-place thermal-management component is made of a second dielectric material different from the first dielectric material.

In some embodiments, the second dielectric material has a thermal conductivity greater than 0.5 W/mK.

In some embodiments, the second dielectric material has a thermal conductivity greater than 1.0 W/mK.

In some embodiments, the first dielectric material has a thermal conductively less than 0.5 W/mK.

In some embodiments, the first dielectric material has a thermal conductivity less than 0.3 W/mK.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1A is a bottom isometric view of a battery module of the present disclosure that includes a housing having an integrated formed-in-place thermal-management component;

FIG. 1B is a bottom isometric view of the battery module of FIG. 1A, showing the housing prior to forming the formed-in-place thermal management component;

FIG. 1C is an enlarged cross-sectional view as taken along line 1C-1C of FIG. 1A, showing some internal components of the battery module omitted and the battery core and electronics in block-diagrammatic form in dashed lines for simplicity;

FIG. 2A is a reduced-size bottom isometric view of the main body of the housing of FIGS. 1A and 1B;

FIG. 2B is a top isometric view of the main body of FIG. 2A;

FIG. 3A is a reduced-size isometric view of the battery module of FIG. 1B showing a thermal-management-component forming tool being engaged with the battery module;

FIG. 3B is a reduced-size isometric view of the battery module of FIG. 1B with the thermal-management-component forming tool fully engaged with the battery module;

FIG. 3C is a isometric view of the battery module and the engaged thermal-management-component forming tool of FIG. 3B after applying a flowable material that is the precursor to the formed-in-place thermal-management component;

FIG. 4A is an isometric view of a cylindrical battery module of the present disclosure that includes a housing having a formed-in-place thermal-management component integrated into a sidewall of the housing;

FIG. 4B is an isometric view of the cylindrical battery module of FIG. 4A, showing the housing without the formed-in-place thermal-management component and with a thermal-management-component forming tool engaged therewith;

FIG. 5A is an isometric view of a cylindrical battery module of the present disclosure that includes a housing having a formed-in-place thermal-management component integrated into an end wall of the housing; and

FIG. 5B is an isometric view of the cylindrical battery module of FIG. 5A, showing the housing without the formed-in-place thermal-management component and with a thermal-management-component forming tool engaged therewith.

### DETAILED DESCRIPTION

In some aspects, the present disclosure is directed to battery modules that each include a housing having an integrated formed-in-place thermal-management component. As noted in the Background section above, battery modules having resin-based housings can be lightweight, but they generally lack the ability to thermally manage the battery module. As also noted in the above Background section, an aluminum thermal-management component can be added to a battery module to assist with thermally managing the battery module. However, the addition of an aluminum thermal-management component comes at the expense of significantly increasing the weight of the battery module. In contrast and as will become apparent from reading this entire disclosure, battery modules of the present disclosure that include at least one formed-in-place thermal-management component integrated with the housing can provide the battery module with both lightweight-ness and good thermal-management properties.

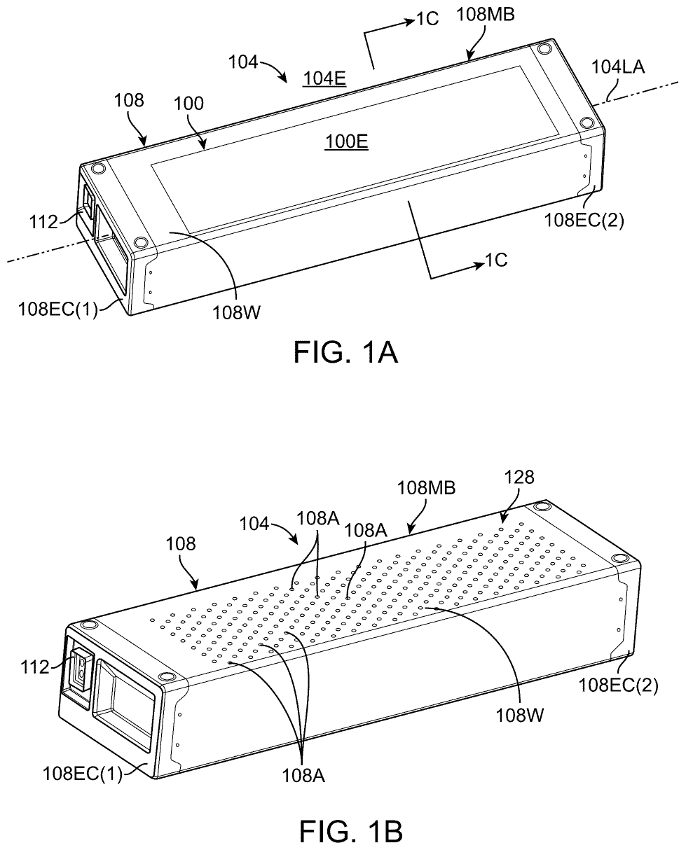

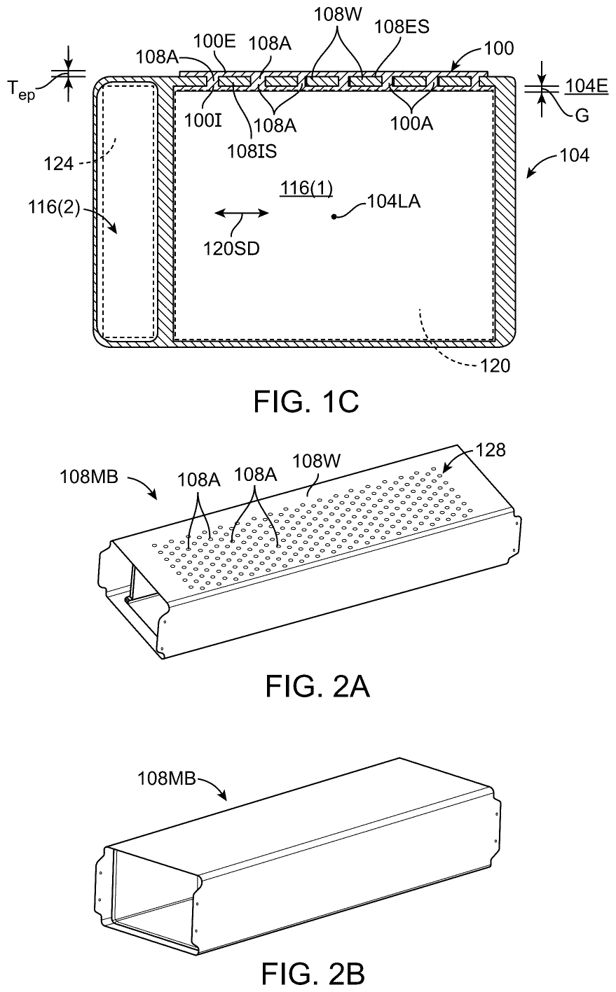

In the context of the present disclosure, including the appended claims, the term “battery module” includes any combination of a housing and battery core contained in the housing and that comprises one or more electrochemical cells. For example, a battery module of the present disclosure may be one having a battery core composed of a plurality of pouch-type cells and a housing that contains the pouch-type cells. In some embodiments of such a battery module, the plurality of pouch-type cells may be wrapped so as to form a unitary stack of such cells, or the pouch-type cells may be unwrapped, perhaps being held together with one another in a manner other than wrapping. The housing of such a battery module may or may not contain battery-management-system (BMS) circuitry and/or other electronics, as the case may be. In some embodiments of such a battery module, the housing may have a rectangular prismatic shape. In this context, the term “rectangular prismatic shape” allows for corners and/or edges of the housing to be rounded while not destroying the general rectangular nature of the housing. An example of a battery module having a rectangular prismatic shape is shown in FIGS. 1A through 3D.

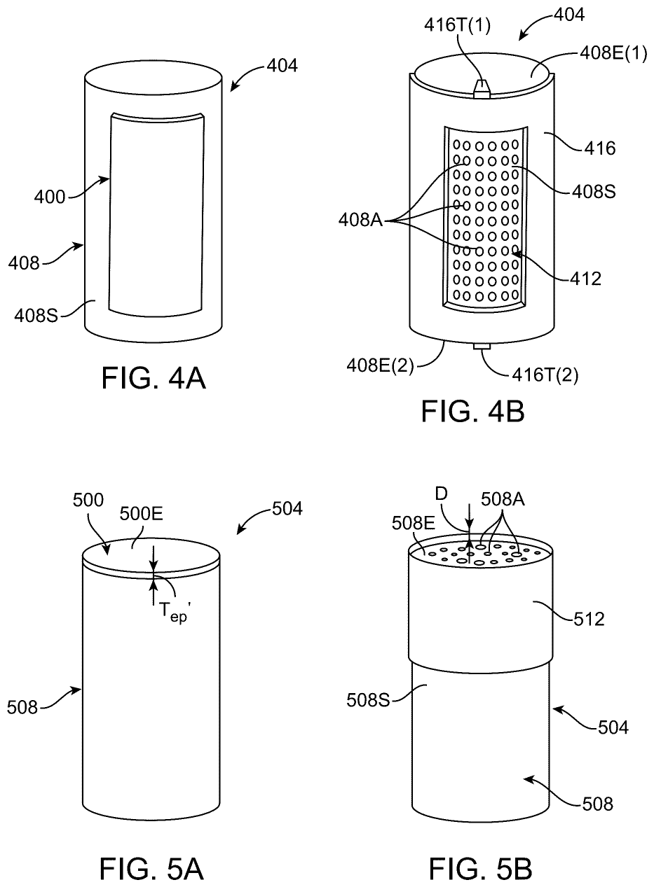

As another example, a battery module of the present disclosure may be one having a battery core contained in the housing and being composed of a spirally wound jellyroll comprising, for example, an anode layer, a separator layer, and a cathode layer, perhaps among other and/or alternative layers. The jellyroll may be contained in a suitable container, for example, along with an electrolyte. In such an example, the housing may be cylindrical in shape. Examples of battery modules having cylindrical housings are shown in FIGS. 4A through 5B.

Each electrochemical cell may be of any suitable chemistry (e.g., lithium-based, sodium-based, potassium-based, lead-based, sulfur-based, etc.) and any suitable type(s) (e.g., intercalating/de-intercalating or plating/stripping, or a combination thereof as between the differing electrodes). For example, each electrochemical cell may have a lithium-based chemistry and be of a lithium-ion type or a lithium-metal type having, respectively, a lithium-ion anode and a lithium-metal anode. Those skilled in the art will readily understand the wide range of electrochemical cells that can be used in battery modules of the present disclosure.

In some embodiments, a battery module of the present disclosure includes a housing that encloses at least one interior space that contains a battery core. The housing has at least one wall with which at least one formed-in-place thermal-management component is integrated. In some instantiations and prior to integrating the formed-in-place thermal-management component(s), some or all of the housing is made of a dielectric material, such as a resin-based material, for example, a resin-based composite. In an example, a resin-based composite includes one or more layers of an impregnatable fabric and/or other reinforcing impregnated and/or covered with one or more suitable resins. In some embodiments, the thermal conductivity of such a material is less than 0.5 W/mK or in a range of about 0.2 W/mK to 0.46 W/mK, among others. As those skilled in the art will readily appreciate, the thermal conductivities are considered to be low and ineffective in the context of thermally managing a battery module.

For each formed-in-place thermal-management component, the corresponding housing wall may be provided with a plurality of apertures that extend entirely through the wall and are arranged, for example, in a regular or non-regular manner. The shapes of each aperture may be any shape desired, such as circular, rectangular, oval, polygonal, etc. The number and size(s) of the apertures may be determined based on the thermally conductive area of the formed-in-place thermal-management component needed to conduct heat from the battery core in the interior space of the housing to the exterior of the housing. This is so because, when the thermal conductivity of the formed-in-place thermal-management component is meaningfully higher than the thermal conductivity of the wall of the housing, the primary thermal pathway from the battery core to the exterior of the housing is through the material of the formed-in-place thermal-management component present within the apertures in the wall. Other considerations for determining the size(s) and or number of apertures for each formed-in-place thermal-management component may include, but not be limited to, the required strength of the wall containing the apertures, the flow characteristics of each flowable material used to form the formed-in-place thermal-management component, and locational requirements for where the flowable material needs to be within the interior space of the housing to provide the requisite heat-conductance functionality of the formed-in-place thermal-management component. Those skilled in the art will appreciate the considerations that need to be made in determining the size(s), shape(s), and number of apertures needed for a particular application.

In the context of the present disclosure, including in the appended claims, the term “formed-in-place” when modifying “thermal-management component” means that the thermal-management component is formed by applying, engaging, injecting, etc., at least one flowable material, which is a precursor to the formed-in-place thermal-management component, to the wall so that the flowable material at least flows into the corresponding apertures, into the interior space of the housing to the extent that internal structure(s) (e.g., battery core, wires, cables, etc.) permit(s), and, optionally, onto an external portion of the wall at the region of the apertures, or apertured region. Once the flowable material(s) has/have been applied and, optionally, shaped or otherwise worked (e.g., to spread, level, etc.), it/they is/are allowed to solidify to the final usable form, i.e., the formed-in-place thermal-management component. In this context, “solidify” and like terms means that each flowable material loses its flowability regardless of the mechanism (e.g., crosslinking (with or without an activator and/or with or without external stimulation), curing, drying, off-gassing, etc.) involved. It is also noted that in the context of “solidifying”, the term “allowed to” includes not only passive allowance (e.g., by passage of time) but also activity, such as, but not limited to application of heat and/or application of another type of electromagnetic radiation (e.g., ultraviolet, microwave, etc.), among other things. Other terms covered by “solidify” include, but are not limited to “harden”, “cure”, “set”, etc.

Each flowable material may be any suitable flowable material that has a thermal conductivity high enough to conduct heat as intended. In some embodiments, it is desired that the thermal conductivity of each flowable material be greater than about 1 W/mK, such as in a range of about 1 W/mK to about 4 W/mK, or about 4 W/mK or greater. In some embodiments, it is desirable that each flowable material and the resulting formed-in-place thermal-management component is a dielectric material to improve the electrical safety of the battery module.

In some embodiments, it is desirable for the entire housing to be made of a lightweight material, such as a lightweight fiber-reinforced resin composite or a plastic, such as a thermoset plastic, and especially a lightweight material that is a dielectric material. When both the housing and the formed-in-place thermal management component are electrically non-conductive, the battery module has relatively great electrical safety compared to a similar battery module having an aluminum housing or one or more metal thermal-management components.

Typically, lightweight housing materials have a relatively low thermal conductivity. For example and as noted above, some desirable fiber-reinforced resin composites have thermal conductivities in the range of about 0.2 W/mK to about 0.3 W/mK, which are too low to effectively conduct heat away from a battery core. However, when such a material is used in combination with a flowable material having a suitably high thermal conductivity, such as, for example, greater than about 1 W/mK, such as in a range of about 1 W/mK to about 4 W/mK, or about 4 W/mK or greater, the thermal conductivity is increased by a factor of about 4× to about 6× or more. In some embodiments, the flowable material can be a thermal adhesive, such as, for example, a PLEXUS® thermal adhesive available from ITW Performance Polymers, Danvers, Massachusetts, among many others.

In some embodiments, one or more spaces, which fill with the flowable material, are located between the battery core and the interior face of the wall containing the plurality of apertures. In some cases, the space(s) are provided by maintaining a gap between the wall and the battery core, for example using spacers, one or more holding members, or simply by making the interior space of the housing larger than the battery core. In the case of the last example, the battery core may be free-floating inside the interior space of the housing, and, when the flowable material is provided when the apertured wall is facing upward, the battery core settles on the lower side of the interior space, creating a gap between the apertured wall and the battery core. After the flowable material has been installed so as to fill the gap and has solidified, the resulting portion of the formed-in-place thermal-management component can hold the battery core firmly in place, at least by way of completely filling the gap and in some instantiations by adhesively bonding to the battery core. In some cases, the space(s) are provided by forming one or more corresponding recesses in the wall on the interior side. In some cases, the space(s) are provided by a combination of maintaining a gap and forming one or more recesses. When one or more recesses are provided on the interior side of the apertured wall, one or more apertures may fluidly communicate with each recess. For example, when the apertures are arranged in linear rows, the apertures in one or more rows may be in fluid communication with a corresponding linear channel formed in the interior face of the wall. The locations of the apertures and any interior recesses provided may be coordinated with locations on the battery pack with thermal contact between the formed-in-place thermal management component and the battery pack.

In some embodiments, the formed-in-place thermal-management component includes an external portion located on the outside face of the apertured wall and extending over the apertures so that the apertures are obscured when the battery module is viewed from a distance. In some cases, the external portion has a uniform thickness and may be characterized as being sheetlike or platelike. In some cases, the external portion stands proud of surrounding portions of the exterior face of the apertured wall. In some cases, the external portion is located in a recess formed in the exterior face of the apertured wall. In some cases, the external portion is partially located in a recess formed in the exterior face and stands proud from surrounding portions of the exterior face.

In some aspects, the present disclosure is directed to methods of making a battery module of the present disclosure that includes at least one formed-in-place thermal-management component. In some embodiments, prior to the formation of the formed-in-place thermal-management component the battery module may include a housing that encloses an interior space that contains a battery core, with the housing having a wall containing a plurality of apertures for installing a flowable material to the battery module. As discussed above, the flowable material is a precursor to the formed-in-place thermal-management component and is installed into the interior space of the housing so as to contact the battery core and to fill the apertures and extend to the exterior of the wall. In this manner, when the flowable material has solidified into the formed-in-place thermal-management component and when the battery core is generating heat, the formed-in-place thermal-management component can work to transfer that heat from the battery core to the exterior of the housing.

In some embodiments, a method of making a battery module of the present disclosure can include further applying the flowable material to the exterior surface of the wall containing the apertures, so that, when the flowable material has solidified into the formed-in-place thermal-management component, the formed-in-place thermal-management component has a portion inside of the housing and a portion outside of the housing, which portions are formed monolithically with portions of the formed-in-place thermal-management component contained in the apertures. In this manner, there is a continuation flow path within the formed-in-place thermal-management component for heat from the battery core.

In some embodiments, a thermal-management-component forming tool is used to form the portion of the formed-in-place thermal-management component present on the exterior of the wall containing the apertures. In some examples, the thermal-management-component forming tool has a frame defining an opening sized to the desired size of the portion of the formed-in-place thermal-management component on the exterior of the wall. In some examples, the frame has a thickness equal to or greater than the thickness of the amount of flowable material applied to the exterior of the wall to create the portion of the formed-in-place thermal-management component. Other examples are described below, for example, in connection with FIG. 5B. The foregoing and other aspects of this disclosure are exemplified in the remainder of this Detailed Description section and in the appended drawings.

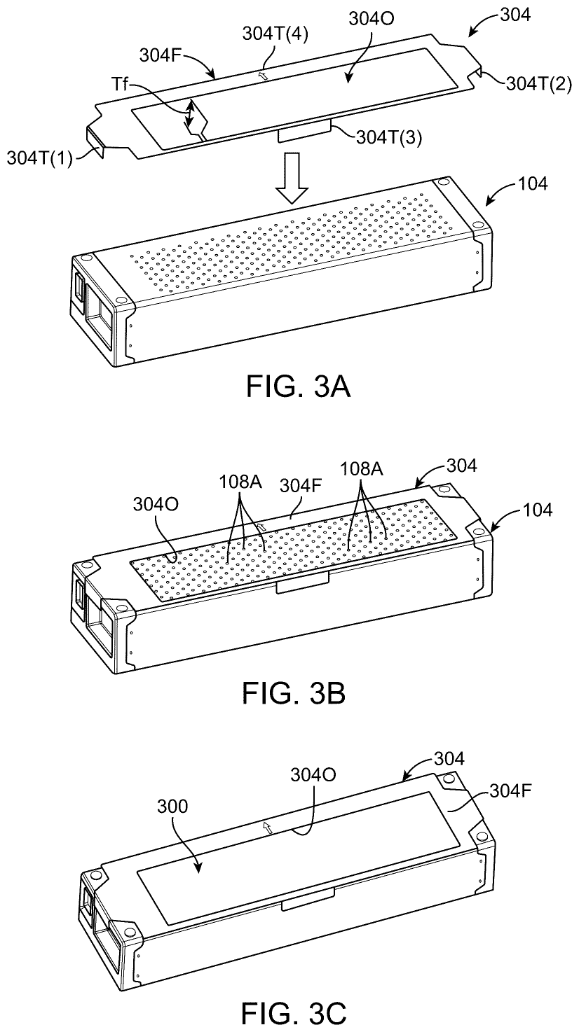

Referring now to the drawings, FIGS. 1A through 3C illustrate both 1) an example formed-in-place thermal-management component 100 (FIGS. 1A and 1C) that is part of an example battery module 104, and 2) an example method of making the formed-in-place thermal-management component (FIGS. 3A through 3C). FIGS. 1A and 1C each show the battery module 104 with the formed-in-place thermal-management component 100 in place, and FIG. 1B shows the battery module before forming the formed-in-place thermal-management component. As seen in each of FIGS. 1A and 1B, in this example the battery module 104 includes a housing 108 that has a generally rectangular prismatic shape and includes a main body 108 MB and first and second end closures 108EC(1) and 108EC(2) closing the opposite ends of the main body. For completeness, FIGS. 2A and 2B show views of the main body 108 MB of the housing 108 prior to the battery module 104 (FIG. 1A) being constructed.

In embodiments of a battery module other than the embodiment shown in FIGS. 1A through 3C, the housing may have another shape, such as cylindrical, among others, and/or may be constructed in another way, such as using two complete halves (i.e., having end closures in place) that are joined at open ends in the middle of the battery module, among others. In terms of the battery module 104 shown in FIGS. 1A and 1B, the location of such a joint between the two halves may be, for example, perpendicular to the longitudinal axis (see, e.g., the longitudinal axis 104LA of FIG. 1A) of the battery module or parallel to the longitudinal axis. It is noted that the shape and dimensions of the housing, here housing 108, may be any suitable shape and dimensions for the design of the battery module at issue. Those skilled in the art will readily appreciate the many shapes and sizes that the housing 108 may take and that the examples shown herein are simply illustrative and not limiting. Generally, the main consideration for the housing 108 is that it have at least one wall, such as wall 108W, or one or more portions thereof, that can receive the formed-in-place thermal-management component 100. Each end closure 108EC(1) and 108EC(2) may be any suitable end closure, such as the end closure 108EC(1) shown that includes an electrical connector 112, perhaps among other things.

As seen in FIG. 1C, in this example the housing 108 defines two interior spaces 116(1) and 116(2) that contain, respectively, a battery core 120 and electronics 124, such as, for example, a battery management system (BMS) and associated circuitry. The battery core 120 may be any suitable battery core that is based on any suitable chemistry as noted above. For example, the battery core 120 may include one or more individual cells (e.g., pouch-type cells), and when multiple cells are present, they may be stacked with one another. The battery chemistry may involve a suitable active ion species, such as lithium, sodium, potassium, sulfur, lead, and any suitable electrolyte(s) in any appropriate form(s), such as liquid, gel, and/or solid. Each electrode may be of any suitable type, such as a plating/stripping type or an intercalating/de-intercalating type. In one nonlimiting example, the battery core 120 comprises a plurality of lithium-metal cells stacked with one another along a stacking direction 120SD, which in this example extend perpendicularly to the longitudinal axis 104LA. In this particular example, the housing 108 is particularly designed to apply pressure to the battery core 120 in the stacking direction 120SD and to resist pressure that builds within the battery core when the anodes (not shown) plate with lithium during charging. Those skilled in the art will understand how to design the housing 108 to handle such pressures from the battery core 120. In some embodiments, the second interior space 116(2) need not be provided, as any electronics 124, if any, can be located elsewhere.

As seen in FIGS. 1B, 1C and 2A, in this example the wall 108W has a plurality of apertures 108A (only a few labeled to avoid clutter) that are arranged in a pattern with an apertured region 128. The apertures 108A are provided for two purposes. First, the apertures 108A allow a flowable material 300 (FIG. 3C), which is a precursor to the formed-in-place thermal-management component 100 (FIG. 1A), to flow through the wall 108W to and into the interior space 116(1) so as to contact the battery core 120. Second, the apertures 108A provide continuity of the formed-in-place thermal-management component 100 (FIG. 1A) from the battery core 120 to the exterior 104E of the module 104 to provide a monolithic continuous path for the flow of heat from the battery core to the exterior of the module. In this manner and during use of the battery module 104, the formed-in-place thermal-management component 100 can conduct heat away from the battery core 120 to a heat sink (not shown) that is in thermal communication with the formed-in-place thermal-management component on the exterior of the battery module to help with thermal management of the battery module.

Depending on the respective thermal conductivities of the wall 108W and the formed-in-place thermal-management component 100, the number and/or size(s) of the apertures 108A may vary. For example, when the thermal conductivity of the wall 108W is relatively low, such as when the wall is made of a lightweight composite material of relatively very low thermal conductivity, the number of apertures 108A may need to be greater than the number of apertures needed for a situation wherein the thermal conductivity of the wall is higher. In addition or alternatively, in this scenario the size(s) of the apertures 108A may be made larger for the lower-thermal-conductivity material. Depending on the type of battery module 104 at issue (e.g., lithium-metal versus lithium-ion) the housing 108, therefore, the wall 108W, may need to carry relatively large loads, such as tensile loads in the case of a lithium-metal battery core 120 where the wall must carry a relatively large tensile load. In such cases, care must be taken to ensure that either the wall 108W itself or the composite formed by the wall and the formed-in-place thermal-management component 100 is robust enough to carry such loads. Those skilled in the art will be able to design the housing 108, including the size(s) and number of the aperture(s) 108A, as well as the pattern of the apertures in the apertured region 128, for the particular conditions and design requirements of the battery module 104 without undue experimentation.

Referring to FIG. 1C, and also to FIG. 1A, in this example the formed-in-place thermal-management component 100 includes an exterior portion 100E located on the exterior surface 108ES of the wall 108W. In this example and as best seen in FIG. 1A, the exterior portion 100E extends over the apertures 108A (FIGS. 1B and 3C) across the entire apertured region 128 (FIG. 1B) so as to cover all of the apertures in a sheetlike or platelike manner. Also in this example, the exterior portion 100E of the formed-in-place thermal-management component 100 stands proud of the exterior surface of the wall 108W by its thickness, Tₑₚ. In some embodiments, a continuous, sheetlike/platelike exterior portion 100E is desirable to increase the surface area of the formed-in-place thermal-management component 100 for engagement with an external heat sink (not shown). Although the exterior portion 100E stands proud of the exterior surface 108ES of the wall 108, in other embodiments the wall may include a recess (not shown) in which the exterior portion is formed. In an example, the depth of such recess may be equal to the thickness Tₑₚ of the exterior portion 100E. In some embodiments, the exterior portion 100E may not be provided, such that the portions 100A of the formed-in-place thermal-management component 100 within the apertures 108A are the parts of the formed-in-place thermal-management component that contact a heat sink.

As seen in FIG. 1C, the formed-in-place thermal-management component 100 has an internal portion 100I that fills a gap, G, between the battery core 120 and the wall 108W. In some embodiments, the gap G is on the order of a 1 mm to 2 mm or less. In a nonlimiting example, the gap G is in a range of 0.5 mm to 1 mm. That said, the gap G in other embodiments may be larger than 2 mm. In some embodiments, the battery core 120 is firmly held in place by walls of the housing 108 other than the wall 108W, such that when the internal portion 100I of the formed-in-place thermal-management component 100 is in place, the battery core 120 is fully constrained within the interior space 116(1). In addition, having the battery core 120 effectively bonded in place to the housing 108 will increase the modal stiffness of the battery module 104. In some embodiments, the bond between the formed-in-place thermal-management component 100 and the battery core 120 provides substantially the only immobilizing of the battery core within the interior space 116(1). In some embodiments, the interior surface 108IS of the wall 108 may include channels or other recesses (not shown) that aid in the distribution of the flowable material 300 (FIG. 3C) within the gap G (FIG. 1C).

FIGS. 3A through 3C illustrate an example method of making the formed-in-place thermal-management component 100 of the battery module 104 (FIG. 1A). In this example, a thermal-management-component forming tool 304 is used to assist in forming the formed-in-place thermal-management component 100 (FIG. 1A). Referring first to FIG. 3A, the method may begin by engaging the thermal-management-component forming tool 304 with the battery module 104. The thermal-management-component forming tool 304 includes a frame 304F that defines an opening 3040 that is sized and shaped to define the size and shape of the exterior portion 100E of the formed-in-place thermal-management component 100 (FIGS. 1A and 1C). In this example, the thermal-management-component forming tool 304 includes a set of alignment tabs 304T(1) through 304T(4) that engage corresponding respective walls of the battery module 104 so as to hold the thermal-management-component forming tool 304 in proper position, as seen in FIG. 3B, during the process of applying the flowable material 300 (FIG. 3C) to the battery module.

FIG. 3C shows the battery module 104 with the thermal-management-component forming tool 304 in place and with the flowable material 300 fully in place, including within the opening 3040 so as to form the precursor to the exterior portion 100E (FIGS. 1A and 1C) of the formed-in-place thermal-management component 100. As those skilled in the art will readily appreciate, the flowable material 300 may be applied in any manner suitable for the relevant conditions and parameters. For example, if the flowable material 300 has a relatively low viscosity and/or the apertures 108A (FIG. 3B) are large enough, then it may be enough to simply pour it into the region of the opening 3040 of the thermal-management-component forming tool 304 and allow it to flow into the apertures and fill the gap G (FIG. 1C) within the interior space 116(1) of the housing 108. As another example, if the flowable material 300 has a relatively high viscosity and/or the apertures 108A (FIG. 3B) are not large enough, then the flowable material may need to be injected or otherwise forced into the gap G (FIG. 1C) and perhaps into the apertures as well. In some embodiments, the frame 304F of the thermal-management-component forming tool 304 may have a thickness, Tf, (FIG. 3A) that is equal to or greater than the thickness Tₑₚ (FIG. 1C) of the exterior portion 100E of the formed-in-place thermal-management component 100. Depending on the character of the flowable material 300, a screeding tool (not shown) may be dragged along the upper surfaces of the frame 304F to screed the flowable material within the opening 3040 of the thermal-management-component forming tool 304. In other embodiments, the thermal-management-component forming tool 304 may include more than one opening 3040. Once the flowable material 300 has suitably solidified, the thermal-management-component forming tool 304 is removed (not shown, but see FIG. 1A) from the battery module 104.

As noted above, formed-in-place thermal-management components of the present disclosure can be used with a battery module having shapes other than a right-rectangular-prismatic shape. FIG. 4A and FIG. 5A show, respectively, two example formed-in-place thermal-management components 400 and 500 used with corresponding cylindrical battery modules 404 and 504. Although not shown, the battery core of each of cylindrical battery modules 404 and 504 may be, for example, of the spirally wound jellyroll type.

Turning first to FIGS. 4A and 4B, in this example the battery module 404 includes a housing 408, and the formed-in-place thermal-management component 400 is located on the sidewall 408S of the housing. Other than the formed-in-place thermal-management component 400 being curved, in all other aspects it may be the same as or similar to the formed-in-place thermal-management component 100 of FIG. 1A. FIG. 4B shows the battery module 404 prior to the formed-in-place thermal-management component 400 being formed, with the apertures 408A (equivalent to apertures 108A of FIG. 1B) arranged in a desired pattern within an apertured region 412. In this example, a curved thermal-management-component forming tool 416, corresponding generally to the thermal-management-component forming tool 304 of FIGS. 3A through 3C, is shown engaged with the housing 408. The thermal-management-component forming tool 416 is curved to match the curvature of the housing 408, and in this example the thermal-management-component forming tool includes a pair of positioning tabs 416T(1) and 416T(2) for engaging the opposite end walls 408E(1) and 408E(2) of the housing. Other aspects and features of the thermal-management-component forming tool 416 may be the same as or similar to the thermal-management-component forming tool 304 of FIGS. 3A through 3C.

FIGS. 5A and 5B illustrate providing the formed-in-place thermal-management component 500 on the end wall 508E (FIG. 5B) of the housing 508. Other than its circular shape (in this example), the formed-in-place thermal-management component 500 (FIG. 5A) may be the same as or similar to the formed-in-place thermal-management component 100 of FIG. 1A. FIG. 5B shows the apertures 508A in the end wall 508E prior to forming the formed-in-place thermal-management component 500, as well as a thermal-management-component forming tool 512, which in this case is simply a circular sleeve that snugly engages the sidewall 508S of the housing 508 and extends above (relative to the orientation in FIG. 5B) the end wall 508E by a distance, D, equal to or greater than the thickness, Tₑₚ′, of the exterior portion 500E (FIG. 5A) of the formed-in-place thermal-management component 500. The additional examples and embodiments of FIGS. 4A through 5B are provided to illustrate the flexibility and wide applicability of a formed-in-place thermal-management component made in accordance with the present disclosure.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A battery module, comprising:
a housing that encloses a first interior space, the housing having a wall composed of a first dielectric material and having an exterior side;
a battery core comprising one or more electrochemical cells; and
a formed-in-place thermal-management component extending through the wall of the housing so that, during use of the battery module, the formed-in-place thermal management component can conduct heat from the battery core to the exterior side of the wall when the battery core generates the heat.

2. The battery module of claim 1, wherein the wall comprises a plurality of apertures, and the formed-in-place thermal-management component extends through the wall by way of the plurality of apertures.

3. The battery module of claim 2, wherein the formed-in-place thermal-management component has an external portion extending over the plurality of apertures.

4. The battery module of claim 1, wherein the formed-in-place thermal-management component is composed of a thermal adhesive.

5. The battery module of claim 1, wherein the formed-in-place thermal-management component is made of a second dielectric material different from the first dielectric material.

6. The battery module of claim 5, wherein the second dielectric material has a thermal conductivity greater than 0.5 W/mK.

7. The battery module of claim 5, wherein the second dielectric material has a thermal conductivity greater than 1.0 W/mK.

8. The battery module of claim 6, wherein the first dielectric material has a thermal conductively less than 0.5 W/mK.

9. The battery module of claim 8, wherein the first dielectric material has a thermal conductivity less than 0.3 W/mK.

10. The battery module of claim 1, wherein the exterior side of the wall has an external surface, and the formed-in-place thermal-management component has an external portion having an exterior face spaced from the external surface of the wall.

11. The battery module of claim 10, wherein the wall comprises a plurality of apertures, and the formed-in-place thermal-management component extends through the wall by way of the plurality of apertures, and the external portion extends over the plurality of apertures.

12. The battery module of claim 1, wherein the formed-in-place thermal-management component is adhesively bonded to the battery core.

13. The battery module of claim 1, wherein the housing has a rectangular transverse cross-sectional shape.

14. The battery module of claim 13, wherein the battery core comprises a plurality of electrochemical cells of the pouch type.

15. The battery module of claim 14, wherein each electrochemical cell is a lithium cell.

16. The battery module of claim 15, wherein each electrochemical cell is a lithium-metal cell.

17. The battery module of claim 13, wherein the wall is a bottom wall of the housing.

18. The battery module of claim 1, wherein the housing has a circular transverse cross-sectional shape.

19. The battery module of claim 18, wherein the wall is an end wall of the housing.

20. The battery module of claim 1, wherein the housing encloses a second interior space, and the second interior space includes battery-management-system circuitry in operative communication with the battery core.
